(19) United States
(12) Patent Application Publication
(10) Pub. No.: US 2026/0134578 A1
(43) Pub. Date: May 14, 2026

(54) SIGNALING FACE AND VERTEX INFORMATION FOR POLYGON MESH COMPRESSION

(71) Applicant: Tencent America LLC, Palo Alto, CA (US)

(72) Inventors: Chao HUANG, Palo Alto, CA (US); Shan LIU, San Jose, CA (US)

(73) Assignee: Tencent America LLC, Palo Alto, CA (US)

(21) Appl. No.: 19/336,288

(22) Filed: Sep. 22, 2025

Related U.S. Application Data
(60) Provisional application No. 63/720,131, filed on Nov. 13, 2024.

(51) Int. Cl. G06T 9/00; H04N 19/70

(52) U.S. Cl. CPC G06T 9/001; H04N 19/70

(57) ABSTRACT

Some aspects of the disclosure provide a method of mesh decoding. In some aspects, a bitstream is received, the bitstream includes coded information of a polygon mesh, the polygon mesh includes a plurality of vertices that are connected into faces. One or more syntax elements are obtained from a header for at least a portion of the polygon mesh, the one or more syntax elements indicate face information and/or vertex information for at least the portion of the polygon mesh. Connectivity information of the portion of the polygon mesh is determined based on the one or more syntax elements; and the polygon mesh is reconstructed based on at least the connectivity information of the portion of the polygon mesh.

### INCORPORATION BY REFERENCE

The present application claims the benefit of priority to U.S. Provisional Application No. 63/720,131 filed on Nov. 13, 2024. The entire disclosure of the prior application is hereby incorporated by reference in its entirety.

### TECHNICAL FIELD

The present disclosure describes aspects generally related to mesh coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Various technologies are developed to capture and represent the world, such as objects in the world, environments in the world, and the like in 3-dimensional (3D) space. 3D representations of the world can enable more immersive forms of interaction and communication. For example, technology developments in 3D media processing, such as advances in three dimensional (3D) capture, 3D modeling, and 3D rendering, and the like have promoted the ubiquitous presence of 3D media contents across several platforms and devices. In an example, a baby's first step can be captured in one continent, media technology can allow grandparents to view (and maybe interact) and enjoy an immersive experience with the baby in another continent. According to an aspect of the disclosure, in order to improve immersive experience, 3D models are becoming ever more sophisticated, and the creation and consumption of 3D models occupy a significant amount of data resources, such as data storage, data transmission resources. In some examples, 3D meshes can be used as 3D representations of the world.

### SUMMARY

Aspects of the disclosure include bitstreams, methods and apparatuses for mesh encoding/decoding. In some examples, an apparatus for mesh encoding/decoding includes processing circuitry.

Some aspects of the disclosure provide a method of mesh decoding. In some aspects, a bitstream is received, the bitstream includes coded information of a polygon mesh, the polygon mesh includes a plurality of vertices that are connected into faces. One or more syntax elements are obtained from a header for at least a portion of the polygon mesh, the one or more syntax elements indicate face information and/or vertex information for at least the portion of the polygon mesh. Connectivity information of the portion of the polygon mesh is determined based on the one or more syntax elements; and the polygon mesh is reconstructed based on at least the connectivity information of the portion of the polygon mesh.

Some aspects of the disclosure provide a method of mesh encoding. In some examples, values of one or more syntax elements that indicate face information and/or vertex information for at least a portion of a polygon mesh are determined, the polygon mesh includes a plurality of vertices that are connected into faces. Connectivity information of the portion of the polygon mesh is encoded into coded information in a bitstream based on the one or more syntax elements. The one or more syntax elements are included in a header for at least the portion of the polygon mesh within the bitstream.

Aspects of the disclosure also provide an apparatus for mesh decoding. The apparatus for mesh decoding including processing circuitry configured to implement any of the described methods for mesh decoding.

Aspects of the disclosure also provide an apparatus for mesh encoding. The apparatus for mesh encoding including processing circuitry configured to implement any of the described methods for mesh encoding.

Aspects of the disclosure also provide a non-transitory computer-readable medium storing instructions which, when executed by a computer, cause the computer to perform any of the described methods for mesh encoding/decoding.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of a streaming system in some examples.

FIG. 2 is a schematic illustration of an example of a block diagram of a video decoder.

FIG. 3 is a schematic illustration of an example of a block diagram of a video encoder.

FIG. 4 shows an example of an encoding process for mesh processing according to an aspect of the disclosure.

FIG. 5 shows an example of a decoding process for mesh processing according to an aspect of the disclosure.

FIG. 6 shows an example of a polygon fan according to an aspect of the disclosure.

FIG. 7 shows examples of topological configurations for triangle based connectivity coding in some examples.

FIG. 8 shows a table of sets of predictors for different neighborhood configurations in some examples.

FIG. 9 shows a diagram of a polygon mesh for illustrating vertex degree and face degree in some examples.

FIG. 10 shows an example of a primal mesh and a dual mesh according to an aspect of the disclosure.

FIGS. 11-12 show an example of a traversal sequence of the dual-degree algorithm according to an aspect of the disclosure.

FIG. 13 shows a table of codewords and corresponding mesh face types in some examples.

FIG. 14 shows a pseudo code for signaling a mesh face type in a bitstream in some examples.

FIG. 15 shows a pseudo code for signaling a face degree mode of a polygon mesh in a bitstream in some examples.

FIG. 16 shows a pseudo code for signaling a vertex degree mode of a polygon mesh in a bitstream in some examples.

FIG. 17 shows a pseudo code for signaling a vertex degree mode of a polygon mesh in a bitstream in some examples.

FIG. 18 shows a pseudo code for signaling a vertex degree mode of a polygon mesh in a bitstream in some examples.

FIG. 19 shows a table of values of a codeword and corresponding vertex degree modes in some examples.

FIG. 20 shows a pseudo code for signaling a vertex degree mode of a polygon mesh in a bitstream in some examples.

FIG. 21 shows a flow chart outlining a decoding process according to some aspects of the disclosure.

FIG. 22 shows a flow chart outlining an encoding process according to some aspects of the disclosure.

FIG. 23 is a schematic illustration of a computer system in accordance with an aspect.

### DETAILED DESCRIPTION

Aspects of the disclosure provide techniques in the field of mesh processing.

A mesh (also referred to as mesh model) includes several polygons (also referred to as faces) that describe the surface of a volumetric object. Each polygon can be defined by vertices in three dimensional (3D) space and the information of how the vertices are connected, referred to as connectivity information. In some examples, the mesh also includes vertex attributes, such as colors, normals, displacements, and the like, that are associated with the mesh vertices. Further, in some examples, the mesh can include attributes associated with the surface of the mesh by exploiting mapping information that parameterizes the mesh with two dimensional (2D) attribute maps. Such mapping is usually described by a set of parametric coordinates, referred to as UV coordinates or texture coordinates, associated with the mesh vertices. 2D attribute maps are used to store high resolution attribute information, such as texture, normals, displacements, and the like. The 2D attribute maps can be used for various purposes such as texture mapping, shading and mesh reconstruction and the like.

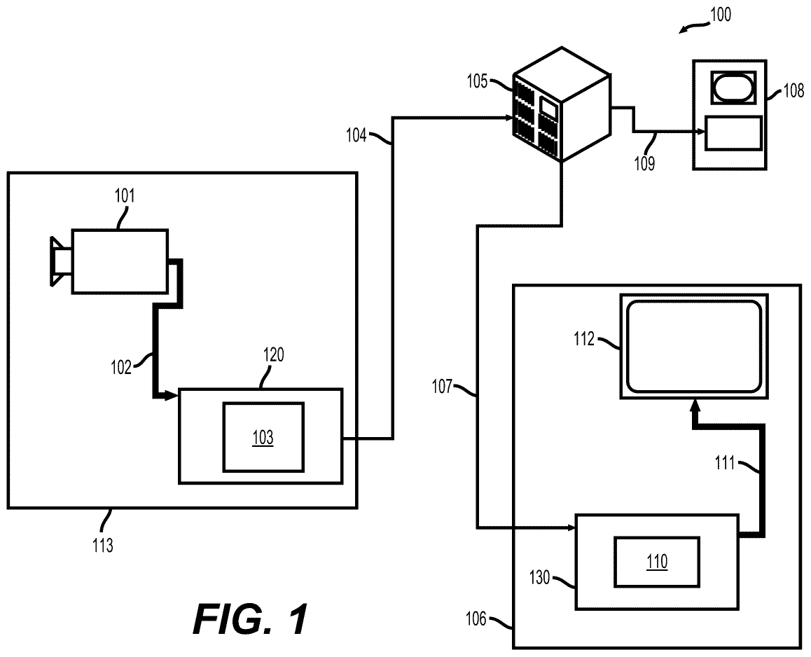

FIG. 1 shows a block diagram of a streaming system (100) in some examples. The streaming system (100) is an example of an application for the disclosed subject matter, a mesh encoder and a mesh decoder in a streaming environment. The disclosed subject matter can be applicable to other mesh enabled applications, including, for example, conferencing, 3D TV, streaming services, storing of compressed 3D data on digital media including CD, DVD, memory stick and the like, and so on.

The streaming system (100) includes a capture subsystem (113), that can include a 3D source (101), for example light detection and ranging (LIDAR) systems, 3D cameras, 3D scanners, a graphics generation component and the like for creating a stream of 3D data (102) that are uncompressed. In an example, the stream of 3D data (102) includes samples that are taken by the 3D camera system. The stream of 3D data (102), depicted as a bold line to emphasize a high data volume when compared to encoded 3D data (104) (or encoded bitstreams), can be processed by an electronic device (120) that includes a 3D encoder (103) coupled to the 3D source (101). The 3D encoder (103) can include hardware, software, or a combination thereof to enable or implement aspects of the disclosed subject matter as described in more detail below. The encoded 3D data (104) (or encoded bitstream), depicted as a thin line to emphasize the lower data volume when compared to the stream of 3D data (102), can be stored on a streaming server (105) for future use. One or more streaming client subsystems, such as client subsystems (106) and (108) in FIG. 1 can access the streaming server (105) to retrieve copies (107) and (109) of the encoded 3D data (104). A client subsystem (106) can include a 3D decoder (110), for example, in an electronic device (130). The 3D decoder (110) decodes the incoming copy (107) of the encoded 3D data and creates an outgoing stream of 3D representation (111) that can be rendered on a display (112) (e.g., display screen) or other rendering device (not depicted). In some streaming systems, the encoded 3D data (104), (107), and (109) (e.g., video bitstreams) can be encoded according to certain 3D coding/compression standards, such as mesh coding/compression standards and the like.

It is noted that the electronic devices (120) and (130) can include other components (not shown). For example, the electronic device (120) can include a 3D decoder (not shown) and the electronic device (130) can include a 3D encoder (not shown) as well.

It is also noted that, in some examples, the 3D encoders and/or the 3D decoders can use 2D encoding/decoding techniques. For example, 3D encoders and/or the 3D decoders can include video encoders or video decoders.

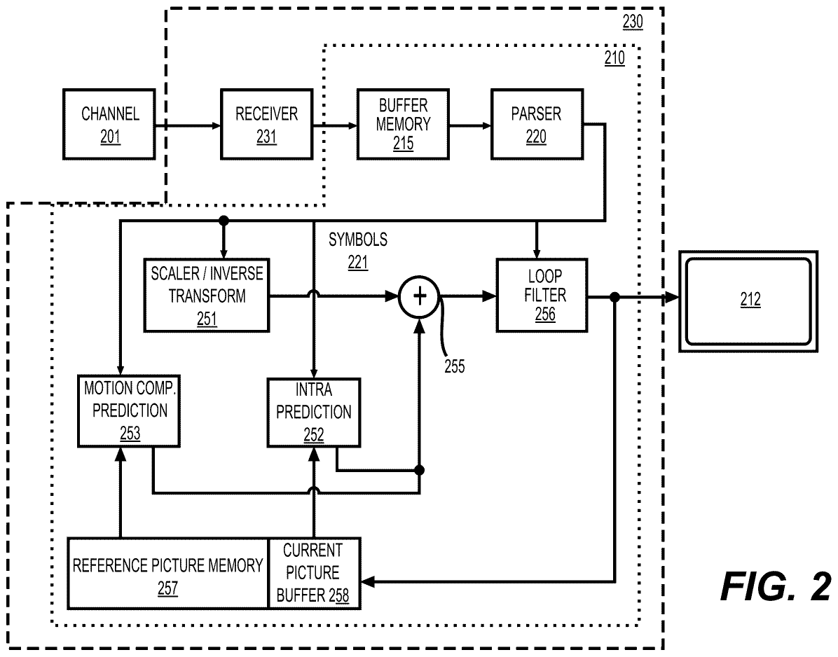

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the 3D decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

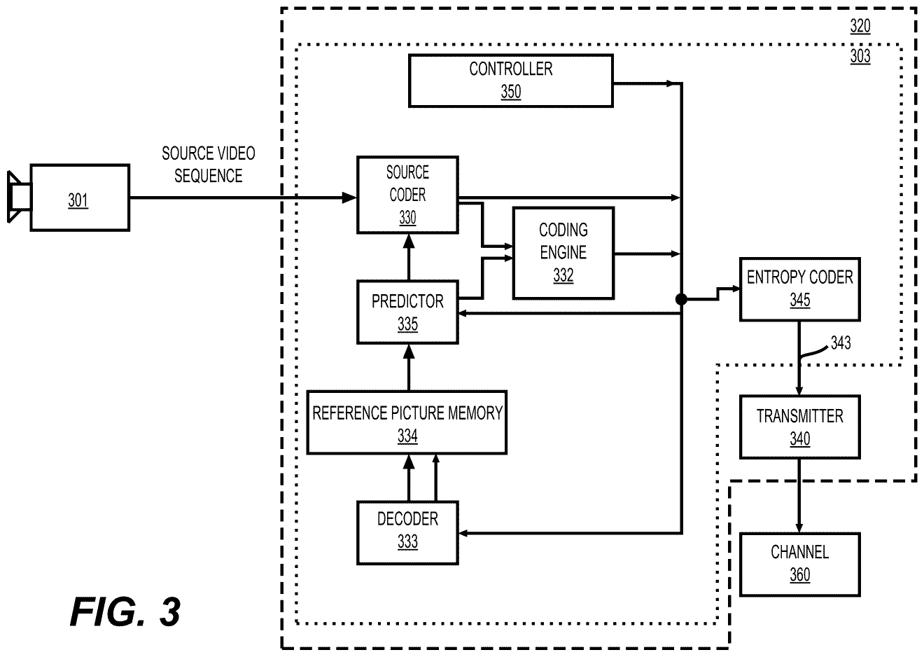

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the 3D encoder (103) in the FIG. 1 example.

The video encoder (303) may receive video samples from a video source (301) (that is not part of the electronic device (320) in the FIG. 3 example) that may obtain video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, ...), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, ...), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks'respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the encoders (103) and (303), and the decoders (110) and (210) can be implemented using any suitable technique. In an aspect, the encoders (103) and (303) and the decoders (110) and (210) can be implemented using one or more integrated circuits. In another aspect, the encoders (103) and (303), and the decoders (110) and (210) can be implemented using one or more processors that execute software instructions.

In some examples, the 3D data includes mesh models, and the 3D encoder (103) can include a mesh encoder, and the 3D decoder (110) can include a mesh decoder.

According to an aspect of the disclosure, a dynamic mesh is a mesh where at least one of the components (geometry information, connectivity information, mapping information, vertex attributes and attribute maps) varies with time. A dynamic mesh can be described by a sequence of meshes (also referred to as mesh frames). In some examples, mesh frames in a dynamic mesh can be representations of a surface of an object at different time, and each mesh frame is a representation of the surface of the object at a specific time (also referred to as a time instance). The dynamic mesh may require a large amount of data since the dynamic mesh may include a significant amount of information changing over time. Compression technologies of meshes can allow efficient storage and transmission of media contents in the mesh representation.

A dynamic mesh sequence may require a large amount of data since the dynamic mesh may include a significant amount of information changing over time. Therefore, efficient compression technologies may be used to store and transmit such contents.

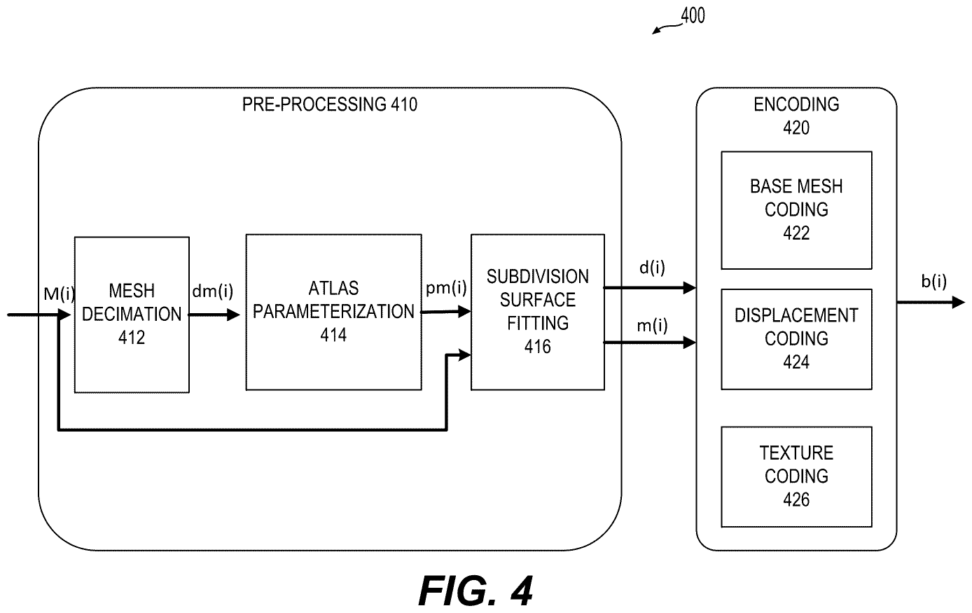

FIG. 4 shows an example of an encoding process (400) for mesh processing according to an aspect of the disclosure. As shown in FIG. 4, the encoding process (400) includes a pre-processing step (410) and an encoding step (420). The pre-processing step (410) receives an input mesh M(i) of ta current frame, and is configured to generate a base mesh m(i) of the current frame and a displacement field d(i) of the current frame according to the input mesh M(i) of the current frame. The displacement field d(i) of the current frame includes displacement vectors. The encoding step (420) is configured to encode the base mesh m(i), the displacement field d(i), and texture information of the base mesh m(i) in some examples. An index i is used to refer to the current frame. In an aspect, a mode decision method can be performed in the encoding process (400) to determine whether inter coding (also referred to as inter frame prediction or an inter mode), intra coding (also referred to as intra frame prediction or an intra mode), or the like is applied to the current frame. For example, the mode decision method can compare a cost of an intra mode and a cost of an inter mode and decide a coding mode of the base mesh m(i) of the current frame based on which one of the costs is smaller. In some examples, a skip mode is used to code the base mesh m(i). In an example, the skip mode is a special mode of the inter mode. In some aspects, the base mesh m(i) may be intra coded, or inter coded, or coded with the SKIP mode.

Still referring to FIG. 4, the pre-processing step (410) may include a mesh decimation process (412), a parameterization process such as an atlas parameterization process (414), and a subdivision surface fitting process (416). The mesh decimation process (412) is configured to down-sample vertices of the input mesh M(i) to generate a decimated mesh dm(i) that can include a plurality of decimated (or down-sampled) vertices. In an example, a number of the plurality of decimated vertices is less than a number of the vertices of the input mesh M(i). The parameterization process such as the atlas parameterization process (414) is configured to map the decimated mesh dm(i) onto a planar domain, such as onto a UV atlas (or a UV map), to generate a re-parameterized mesh pm(i). In an example, the atlas parameterization may be performed based on a video processing tool, such as a UVAtlas tool. The subdivision surface fitting process (416) is configured to take the re-parameterized mesh pm(i) and the input mesh M(i) as inputs and produce a based mesh m(i) together with the displacement field d(i) that includes the displacement vectors or a set of displacements. In an example of the subdivision surface fitting process (416), pm(i) is subdivided by using a subdivision scheme such as an iterative interpolation to obtain a subdivided mesh. The iterative interpolation includes inserting at each iteration a new point in a middle of each edge of the re-parameterized mesh pm(i). Any suitable subdivision scheme may be applied to subdivide pm(i). The displacement field d(i) is computed by determining a nearest point on a surface of the input mesh M(i) for each vertex of the subdivided mesh.

An advantage of the subdivided mesh may include that the subdivided mesh has a subdivision structure that allows efficient compression, while offering a faithful approximation of the input mesh. An increase in compression efficiency may be obtained due to the following properties. The decimated mesh dm(i) may have a low number of vertices and may be encoded and transmitted using a lower number of bits than the input mesh M(i) or the subdivided mesh. Referring to FIG. 4, the base mesh m(i) may be generated from the decimated mesh dm(i). In an example, the base mesh m(i) is the decimated mesh dm(i). As the subdivided mesh may be generated based on the subdivision method, the subdivided mesh may be automatically generated by the decoder when the base mesh or the decimated mesh is decoded (e.g., there is no need to use any information other than the subdivision scheme and a subdivision iteration count). At the decoder side, the displacement field d(i) may be generated by decoding the displacement vectors associated with the vertices of the subdivided mesh. Besides allowing for spatial/quality scalability, the subdivision structure enables efficient transforms such as wavelet decomposition, which can offer high compression performance.

In the FIG. 4 example, the encoding step (420) includes a base mesh coding (422), a displacement coding (424), a texture coding (426), and the like. The base mesh coding (422) is configured to encode geometric information of the base mesh m(i) associated with the current frame. In an intra encoding, the base mesh m(i) may be first quantized (e.g., using uniform quantization) and then encoded, for example, by the coding mode determined using the mode decision method. The coding mode may be the inter mode, the intra mode, the skip mode, or the like. The encoder used to intra code the base mesh m(i) may be referred to as a static mesh encoder. In the inter encoding, a reference base mesh (e.g., a reconstructed quantized reference base mesh m′(j) ) associated with a reference frame indicated by an index j may be used to predict the base mesh m(i) associated with the current frame indicated by the index i. The displacement coding (424) is configured to encode the displacement field d(i) that is generated in the pre-processing step (410). The displacement field d(i) may include a set of displacement vectors (or displacements) associated with the subdivided mesh vertices. The texture coding (426) is configured to encode attribute information of the base mesh m(i). The attribute information may include texture, normal, color, and/or the like. The attribute information may be encoded based on a suitable codec, such as High-Efficiency Video Coding (HEVC) or Versatile Video Coding (VVC).

In an aspect, referring to FIG. 4, a mesh encoding process such as the encoding process (420) starts with a pre-processing (e.g., the pre-processing step (410)). The pre-processing may convert the input mesh (e.g., the input dynamic mesh) M(i) into the base mesh m(i) together with the displacement field d(i) including a set of displacements (or a set of displacement vectors). The encoding step (420) may compress outputs (e.g., m(i), d(i), and the like) from the pre-processing and generate a compressed bitstream b(i). The compressed bitstream b(i) may include a compressed base mesh bitstream, a compressed displacement field bitstream, a compressed attribute bitstream, and/or the like.

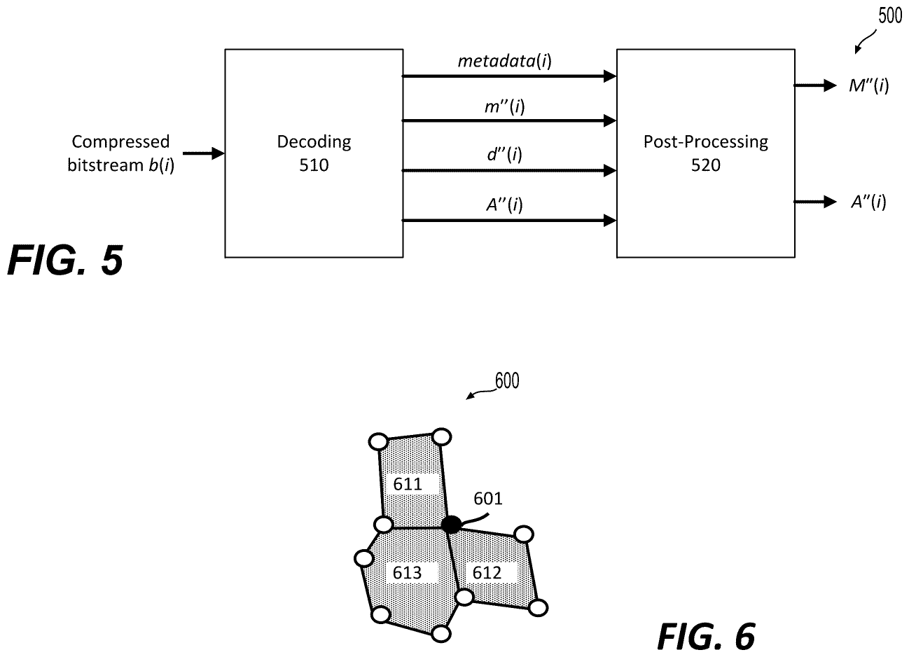

FIG. 5 shows an example of a decoding process (500) for mesh processing according to an aspect of the disclosure. The decoding process (500) may include a decoding step (510) and a post-processing step (520). A compressed bitstream b(i) may be fed to the decoding step (510). In an example, such as for a lossless transmission, the compressed bitstream b(i) is the output b(i) from the encoding process (400). The decoding step (510) may extract various sub-bitstreams such as the compressed base mesh sub-stream, the compressed displacement field sub-stream, the compressed attribute sub-stream, and/or the like. The decoding step (510) may decompress the sub-bitstreams to generate the following components: patch metadata indicated by metadata(i), a decoded base mesh m″(i), a decoded displacement field (including displacements) d″(i), a decoded attribute map A″(i), and/or the like.

In an aspect, the base mesh sub-stream may be fed to a mesh decoder to generate a reconstructed quantized base mesh m′(i). The decoded base mesh (or reconstructed base mesh) m″(i) may be obtained by applying an inverse quantization to m′(i). The displacement field sub-stream including packed and quantized wavelet coefficients that are encoded may be decoded by a video and/or image decoder. Image unpacking and inverse quantization may be applied to the packed quantized wavelet coefficients that are reconstructed to obtain the unpacked and unquantized transformed coefficients (e.g., wavelet coefficients). An inverse wavelet transform may be applied to the unpacked and unquantized wavelet coefficients to generate the decoded displacement field (or reconstructed displacement) d″(i).

The decoded components (e.g., including metadata(i), m″(i), d″(i), A″(i), and/or the like) may be fed to a post-processing step (520). A mesh (also referred to as a decoded/reconstructed mesh) M″(i) may be generated by the post-processing step (520) based on m″(i) and d″(i). In an example, the mesh M″(i) (also referred to as a reconstructed deformed mesh DM(i)) may be obtained by subdividing m″(i) using a subdivision scheme and applying the reconstructed displacements d″(i) to vertices of a subdivided mesh. In an example, the DM (i) may include the displaced curve. In an example, when the encoding process (400), the decoding process (500), and the transmission are lossless, the mesh M″(i) may be identical to the input mesh M(i). When one of the encoding process (400), the decoding process (500), and the transmission is lossy, M″(i) is different from M(i). In various examples, the difference, if any, between M″(i) and M(i) may be relatively small. In an example, an attribute map A″(i) is also generated by the post-processing step (520).

In some examples, the mesh can also include attributes, such as color, normal, and the like, associated with the vertices. The attributes can be associated with the surface of the mesh by exploiting mapping information that parameterizes the mesh with 2D attribute maps. The mapping information is usually described by a set of parametric coordinates, referred to as UV coordinates or texture coordinates, associated with the mesh vertices. 2D attribute maps (referred to as texture maps in some examples) are used to store high resolution attribute information such as texture, normals, displacements etc. Such information could be used for various purposes such as texture mapping and shading.

According to some aspects, a polygon mesh encoder is used for base mesh coding. The polygon mesh encoder includes a geometry encoder and an attribute encoder. The geometry encoder is configured to generate a geometry compressed bitstream and the attribute encoder is configured to generate an attribute compressed bitstream. The geometry compressed bitstream and the attribute compressed bitstream are multiplexed into a final bitstream in some examples.

In some examples, the geometry encoder can use polygon-fan connectivity coding and polygon-fan geometry coding. For example, the geometry encoder can traverse the vertices of a mesh (also referred to as polygon mesh in some examples) according to an order reproducible at the decoder side. For a vertex of the mesh, the geometry encoder can decompose the faces (e.g., also referred to as polygons, polygon faces in some examples) incident to the vertex into a set of polygon-fans sharing the vertex as a pivot. A polygon fan includes one or more faces (e.g., polygons) that are incident to a same vertex (referred to as pivot vertex), and the one or more faces are consecutive faces, two neighboring faces in the one or more consecutive faces share an edge. The polygon fans that are incident to the vertex (pivot vertex) can be triangulated and encoded using triangle based connectivity coding and triangle based geometry coding in some examples.

In some aspects, a polygon mesh can include geometry information and connectivity information. In some examples, the geometry information is described by a set of 3D positions associated with the vertices of the polygon mesh. In an example, (x,y,z) coordinates can be used to describe the 3D positions of the vertices, and are also referred to as 3D coordinates. In some examples, the connectivity information includes a set of vertex indices that describes how to connect the vertices to create a 3D surface.

FIG. 6 shows an example of a polygon fan (600) according to an aspect of the disclosure. The polygon fan (600) includes three incident faces (611)-(613) that share a pivot (or a pivot vertex) (601). In an aspect, all faces in a polygon-fan are incident to a pivot vertex, and the polygon-fan includes consecutive faces. Two of the consecutive faces can share an edge.

In an example, connectivity and geometry of polygon-fans are encoded in an interleaved manner. For each polygon-fan, connectivity information of the respective polygon-fan is encoded. The connectivity information is then used to assist the geometry information encoding.

In some examples, the connectivity and geometry of polygon-fans are coded using triangle based connectivity coding and triangle based geometry coding. To apply the triangle based connectivity coding, a polygon fan of one or more faces (polygons) is first triangulated and the number of triangles for the polygon fan is compressed, for example using a context adaptive binary arithmetic coding. The connectivity of the triangles of the polygon fan is compressed using topological configurations.

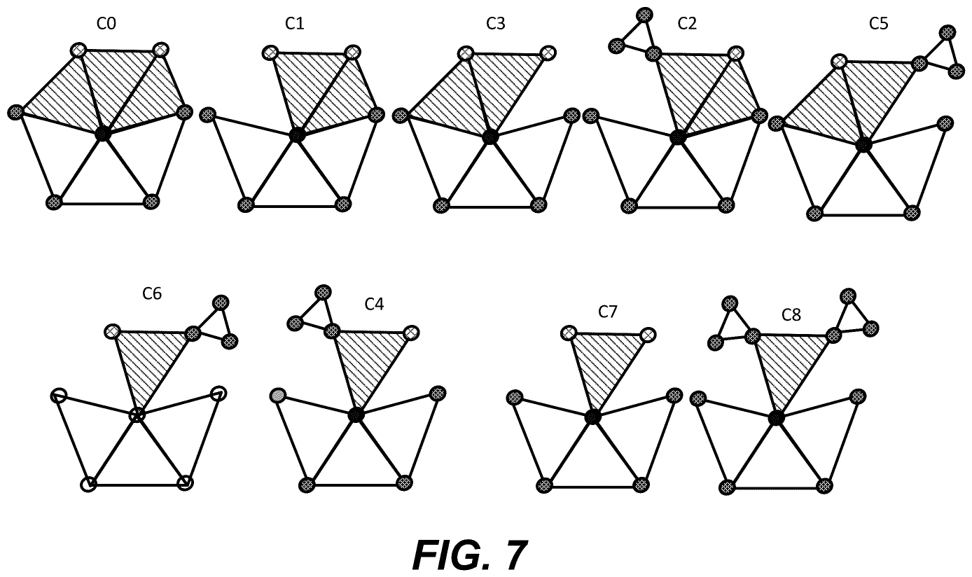

FIG. 7 shows examples of topological configurations C0-C8 for triangle based connectivity coding in some examples. In the FIG. 7 example, polygon fans are triangulated, such as shown by the shaded triangles. For example, the polygon-fan of C0 includes 3 shaded triangles, the polygon-fan of C1 includes 2 shaded triangles, and the polygon-fan of C4 includes 1 triangle.

In some examples, a polygon fan is triangulated, and is categorized into one of the topological configurations, such as one of C0-C8 in FIG. 7, according to the location relationship to neighboring coded portions (e.g., blank triangles shown in FIG. 7.)

In some examples, to apply the triangle based geometry coding, the vertex positions are encoded by applying prediction and compressing the prediction residuals, for example using context adaptive binary arithmetic coding. The current vertex can be predicted according to already geometry coded (encoded/decoded) vertices, such as vertices of neighboring triangles with geometry coded (encoded/decoded). In some examples, according to local neighborhood configuration, a set of predictors can be considered.

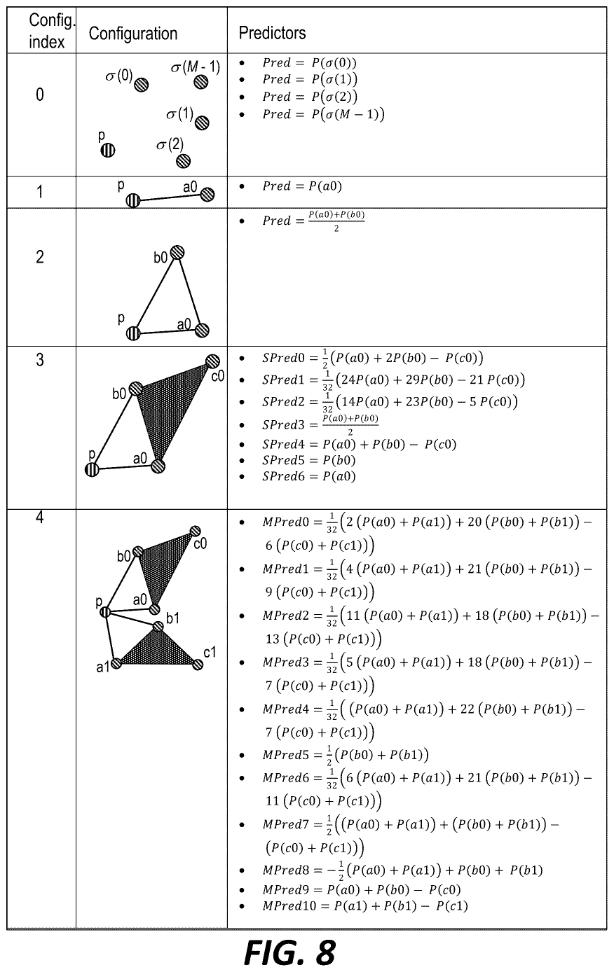

FIG. 8 shows a table of sets of predictors for different neighborhood configurations in some examples. In the FIG. 8 example, a current vertex (denoted by p in FIG. 8) can be categorized into one of 5 configurations (e.g., configuration 0 to configuration 4 in FIG. 8). For each configuration, a set of predictors can be considered. In some examples, a selected predictor from the set of predictors can be suitably coded based on an index of the selected predictor. The selected predictor is used to generate predicted geometry information of the current vertex. Further, the prediction residual is calculated at the encoder side based on the geometry information of the current vertex and the predicted geometry information, and the prediction residual is suitably coded for example using adaptive binary arithmetic coding.

In some aspects, a dual-degree based technique can be used to code connectivity of polygon meshes with arbitrary face or vertex degrees. The dual-degree based technique exploits the duality between the primal and dual mesh to encode the connectivity by generating two sequences of symbols, the vertex degree and face degree.

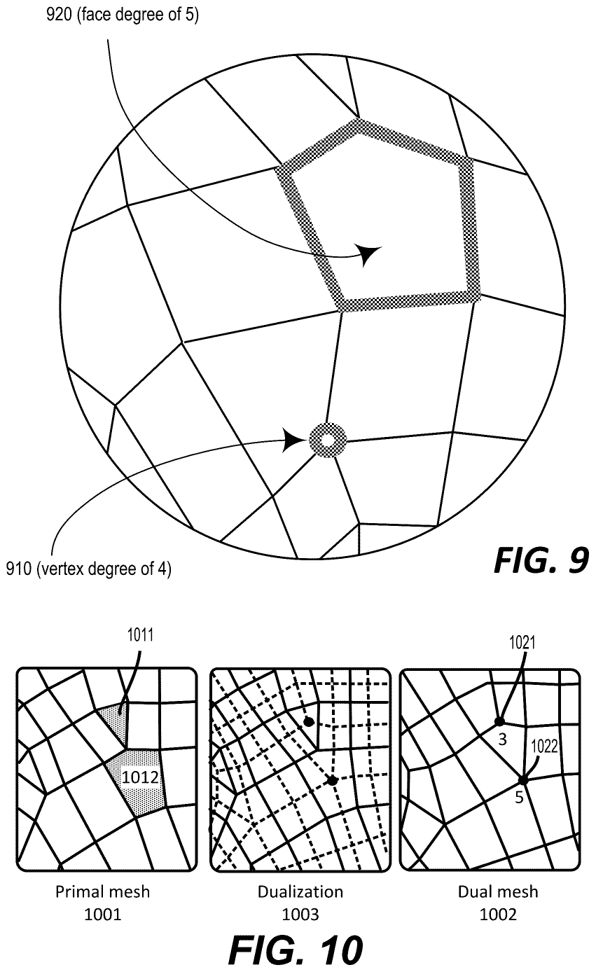

FIG. 9 shows a diagram of a polygon mesh for illustrating vertex degree and face degree in some examples. In an example, a vertex degree of a vertex is also referred to as a valence of the vertex. A vertex degree of a vertex specifies a number of edges incident to the vertex. In the FIG. 9 example, four edges are incident to a vertex (910), thus the vertex (910) has a vertex degree of 4. A face degree of a face specifies a number of incident edges of the face. In the FIG. 9 example, five edges are incident to a face (920), thus the face (920) has a face degree of 5.

FIG. 10 shows an example of a primal mesh (1001) and a dual mesh (1002) according to an aspect of the disclosure. The dual mesh (1002) may be built by a dualization process (1003), for example, by placing one node in each original face in the primal mesh (1001) and connecting the nodes through each edge incident to two original faces in the primal mesh (1001). Thus, an original face in the primal mesh (1001) having a face degree of N1 corresponds to a vertex in the dual mesh (1002) having a vertex degree of N1 where the vertex is the node inside the original face. Referring to FIG. 10, an original face (1011) in the primal mesh (1001) having a face degree of 3 corresponds to a vertex (1021) in the dual mesh (1002) having a vertex degree of 3. Referring to FIG. 10, an original face (1012) in the primal mesh (1001) having a face degree of 5 corresponds to a vertex (1022) in the dual mesh (1002) having a vertex degree of 5.

The coding performance of the dual-degree based technique depends on the mesh regularity, which measures the variance of the vertex and/or face degree. For example, the less of the vertex/face degree variance, the more regular of the mesh, and the dual-degree based technique achieves the higher of the connectivity coding efficiency. In some examples, the dual-degree based technique can achieve near-optimal for worst-case meshes, the entropy of the two sequences of symbols can be proven to achieve Tutte entropy bound for planar graphs of 2 bits per edge.

In some examples, vertex and face data structures may be maintained explicitly. For a vertex, a vertex degree (VD) and references to all incident faces in an order (e.g., a counterclockwise order) may be stored in a data structure associated with the vertex. For a face, a face degree (FD) and references to all incident vertices in an order (e.g., a counterclockwise order) may be stored. Vertices and faces may go through a sequence of states such as an empty state, an active state, and a complete state. In an example, at a given time at most one face is active, and multiple vertices may be active. In an example, the multiple active vertices may be held in an active vertex queue. When a face is processed, for example, moved from an empty state (e.g., when the face is not processed), to an active state (e.g., when the face is being processed), and then to a complete state (e.g., when the face is processed), all vertices of the face that are not yet active may be activated through insertion into the active vertex queue. Consequently, each active vertex has at least one complete incident face. When none of faces incident to a vertex is processed, the vertex is not an active vertex and is in an empty state. The vertex is not visited. When all the faces incident to a vertex have become complete (e.g., all the faces are processed), the vertex changes its state to complete (e.g., the vertex is processed) and may be removed from the active vertex queue.

In some examples, the active vertex queue is an active vertex priority queue where an active vertex having the highest priority is traversed prior to other active vertices in the active vertex queue. For example, the active vertex having the highest priority is made the current vertex such as the pivot vertex, and is processed and then removed from the active vertex queue. In an example, the active vertex queue represents a boundary between a part of the polygon mesh which has already been traversed and a part of the polygon mesh as yet to be visited.

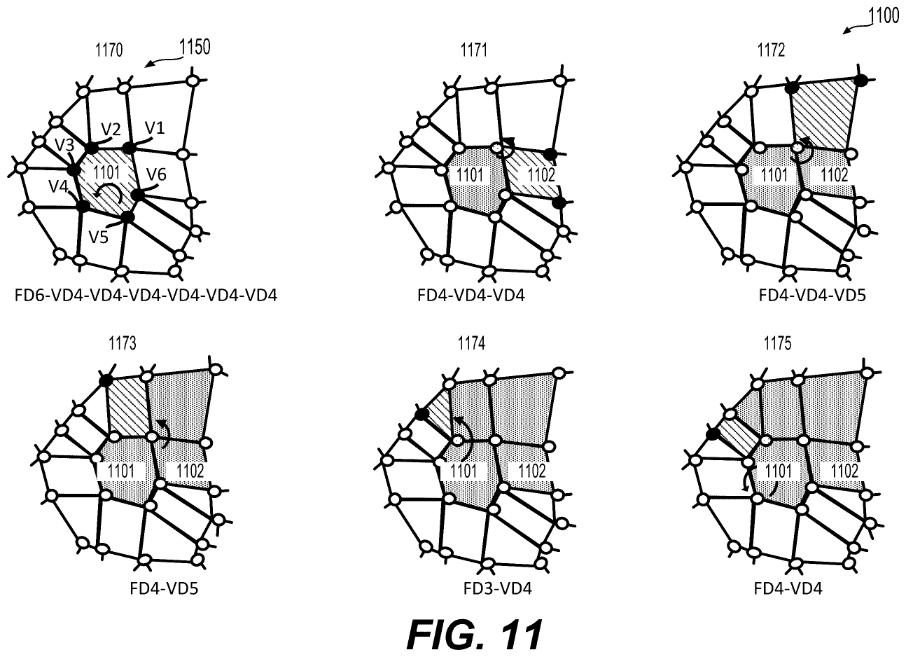

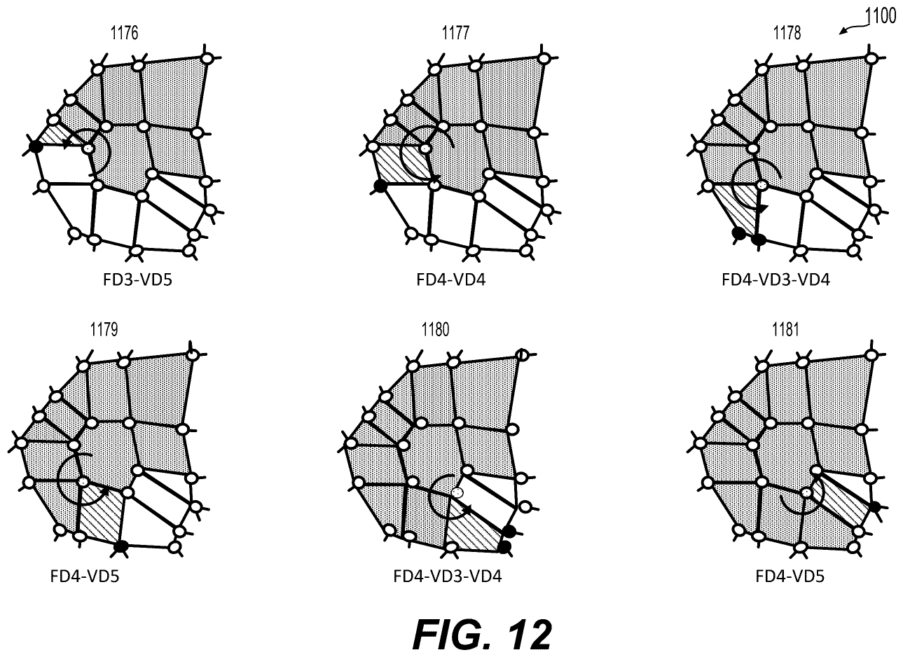

FIGS. 11-12 show an example of a traversal sequence (1100) of the dual-degree algorithm according to an aspect of the disclosure. In an example, the traversal sequence (1100) starts from a seed face (1101) of a polygon mesh (1150). At the beginning (e.g., at a step (1170)), a seed face degree (FD) (e.g., 6 as indicated by FD6) is output along with vertex degrees of all vertices of the seed face (1101). In the example shown in FIG. 11, the seed face (1101) has 6 vertices V 1-V6, each of the vertices has a vertex degree (VD) of 4 as indicated by VD4. The traversal sequence (1100) can proceed to a step (1171).

At the step (1171), a first vertex (e.g., V1) of the seed face (1101) becomes active and a next face (1102) may be traversed, for example, in a counterclockwise order, resulting in one face degree and two vertex valences output, such as FD4, VD4, and VD4.

The traversal keeps going until all the faces and vertices in the polygon mesh (1150) have been visited.

In an example, the seed face (1101) is chosen and all neighbors of the seed face (1101) are traversed recursively until all faces of the corresponding connected component are visited. Referring to FIGS. 11-12, a subset of all neighbors of the seed face (1101) is traversed in the steps (1172)-(1181). A new seed face of the next connected component is then chosen and the traversal sequence (1100) may continue. Every time the encoder traverses the next element of the polygon mesh (1150), the encoder may output some symbol which uniquely identifies a new state. From this stream of symbols, the decoder can reconstruct the polygon mesh (1150). In an example, two sets of symbols may be used to encode vertex degrees and face degrees. At a given moment, the encoder and the decoder may know which type of symbol (face or vertex) is being dealt with.

In an aspect, the mesh traversal such as the traversal sequence (1100) may be started by selecting the seed face (1101). The encoder outputs the face degree of the seed face (1101), followed by the vertex degrees of all the vertices V1-V6 incident to the seed face (1101), e.g., in a counterclockwise order such as FD6-VD4-VD4-VD4-VD4-VD4-VD4 in the step (1170). The vertices (e.g., the 6 vertices V1-V6) may be added to the active vertex queue. The decoder may receive the seed face degree (e.g., FD6) and creates a corresponding face. The decoder may fill all the slots for the incident vertices, moving the incident vertices from the empty to active state, e.g., enters the incident vertices into an active vertex queue of the decoder. Thus, the encoder and the decoder may maintain matching states.

The traversal such as the traversal sequence (1100) may continue by removing the highest priority active vertex from the active vertex queue and making it the current vertex. The algorithm proceeds, for example, counterclockwise around the active vertex, skipping all faces which have already been completed. In an example, for an active vertex, at least one face is completed and at least one incident face is still empty, otherwise the vertex may not be in the active vertex queue.

When the encoder detects an empty face, such as an empty slot in the incident face data structure associated with the current vertex, the encoder may proceed through the following steps: (i) the face is activated and becomes the “current” face, and a face degree of the current face is output; (ii) the current face is added to an appropriate slot in the incident face data structures associated with the current vertex as well as any other active vertices which are incident to current face; (iii) any remaining empty vertices of the current face are activated and the respective vertex degrees output in an order, for example, in a counterclockwise order; and (iv) the current face is complete and removed from processing.

According to an aspect, the traversal sequence (1100) can process elements (e.g., vertices and faces) of the polygon mesh (1150) by alternating vertices and faces. In an aspect, referring to FIGS. 11-12, the active vertex and the subsequently selected active face may be considered as successive pivots, and may be referred to as a pivot vertex and a current face, respectively.

In some aspects, the decoder can use a symmetric procedure, ensuring the same traversal as the encoder. When the decoder finds the first empty face slot in the currently active vertex, the decoder may proceed as follows: (i) read in a face degree and create the face, moving the face from state “empty” to “active,” calling the face the “current” face; (ii) add the current face to the appropriate slot in the active vertex and any other active vertices the current face is incident on; (iii) read the vertex degrees of the remaining empty vertices incident on the current face, activating the remaining empty vertices incident on the current face through insertion into the active vertex queue; (iv) move the current face to the complete state.

In an example, vertices completed during the traversal of the current face are removed from the active vertex queue. The vertices completed during the traversal of the current face no further belong to the boundary of the traversed region. After the current face is processed, the algorithm proceeds to the next face in the currently active vertex until the currently active vertex is complete. Subsequently a new active vertex is taken from the queue and the process repeats until the active vertex queue is empty. If there are some connected components remaining, a new seed face is chosen on it and another component traversal starts.

It is noted that in some examples, the connectivity of a polygon mesh can be efficiently coded by algorithms of the dual-degree based technique. The dual-degree based technique can be directly applied on polygon meshes with any face degrees without triangulation.

Some aspects of the disclosure provide techniques for signaling of face and vertex information for polygon mesh compression.

According to the present disclosure, connectivity of a polygon mesh can be coded with either polygon-fan based techniques or dual-degree based techniques. Both of the polygon-fan based techniques and the dual-degree based techniques require the face and vertex information of the polygon mesh, such as a mesh face type (also referred to as face type), a vertex degree mode, a face degree mode, and the like. A vertex degree of a vertex refers to the number of incident faces of the vertex, and a face degree of a face refers the number of incident vertices of the face. Further, a vertex degree mode of a mesh refers to the most frequent vertex degree of the mesh, and a face degree mode of a mesh refers to the most frequent face degree in the mesh. Further, a mesh face type of a mesh refers to face type information of the mesh, such as whether faces in the mesh are triangles, quadrilaterals, a mix of triangles and quadrilaterals, and the like.

In some aspects, to decode a bitstream for a mesh with connectivity information produced by a polygon-fan based technique or a dual-degree based technique, the face and vertex information of the mesh is signaled in the bitstream. The present disclosure provides various techniques to signal the face and vertex information of a polygon mesh.

In some aspects, face and vertex information of a polygon mesh can be signaled in a header of the polygon mesh (e.g., polygon mesh header) and/or a header of a group of connected components (GOCC) in the polygon mesh. It is noted that while polygon mesh header is used to illustrate techniques to signal the face and vertex information of a polygon mesh, the techniques can be suitably adjusted to signal the face and vertex information in a header of a GOCC.

In some aspects, the face information of the polygon mesh is generalized face information of the polygon mesh, such as the face degree mode which indicates a face degree of a majority of faces in the polygon mesh; the vertex information of the polygon mesh is generalized vertex information of the polygon mesh, such as the vertex degree mode which indicates a vertex degree of a majority of vertices in the polygon mesh. In some aspects, one or more syntax elements in a header for at least a portion of a polygon mesh can indicate face information and/or vertex information for at least the portion of the polygon mesh. Connectivity information of the portion of the polygon mesh can be encoded/decoded based on the one or more syntax elements.

In an aspect, a mesh face type (also referred to as face type) of a mesh can be coded using a 2-bit codeword.

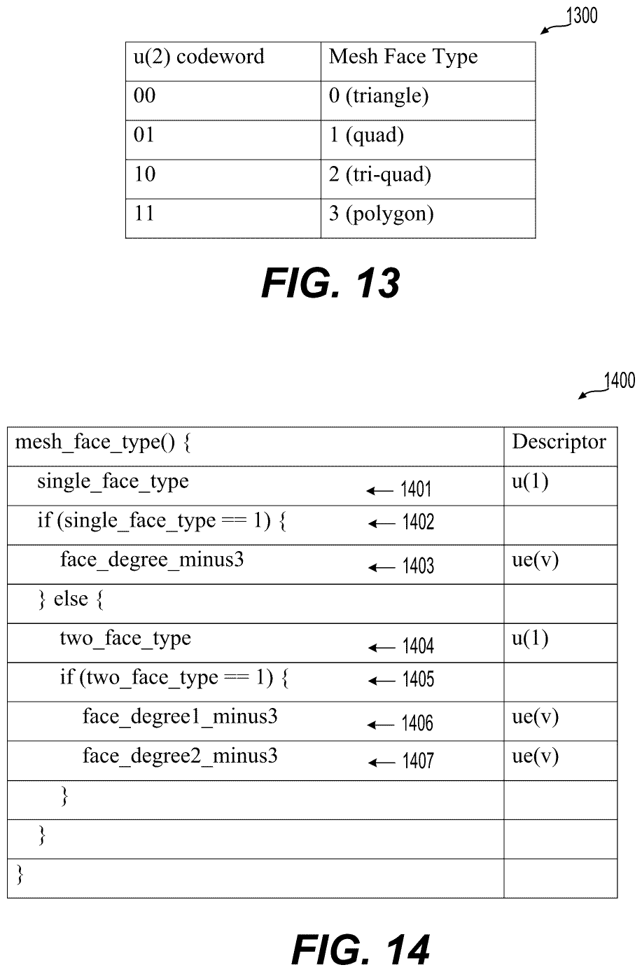

FIG. 13 shows a table (1300) of codewords and corresponding mesh face types in some examples. For example, a codeword “00” indicates a mesh face type 0 (e.g., all polygons in a mesh are triangles); a codeword “01” indicates a mesh face type 1 (e.g., all polygons in a mesh are quadrilaterals); a codeword “10” indicates a mesh face type 2 (e.g., polygons in a mesh include triangles and quadrilaterals); a codeword “11” indicates a mesh face type 3 (e.g., at least one polygon in polygons of a mesh is not any one of triangle and quadrilateral).

It is noted that the correspondence of the codewords and the mesh face types can be changed. For example, a codeword “00” indicates that at least one polygon in polygons of a mesh is not any one of triangle and quadrilateral; a codeword “01” indicates that polygons in a mesh include triangles and quadrilaterals; a codeword “10” indicates that all polygons in a mesh are quadrilaterals; and a codeword “11” indicates that all polygons in a mesh are triangles.

In another aspect, a mesh face type can be signaled using a plurality of bits.

FIG. 14 shows a pseudo code (1400) for signaling a mesh face type in a bitstream in some examples. In the FIG. 14 example, a polygon mesh can have a single type of polygons and two types of polygons.

In the FIG. 14 example, a syntax element “single_face_type” is obtained from the bitstream (shown by (1401) in FIG. 14), the syntax element “single_face_type” indicates whether the polygon mesh has single type of polygons. When the syntax element “single_face_type” indicates that the polygon mesh has single type of polygons (shown by (1402) in FIG. 14), a syntax element “face_degree_minus3” is obtained from the bitstream, such as shown by (1403) in FIG. 14. The syntax element “face_degree_minus3” indicates the face degree of the polygons in the polygon mesh (e.g., a sum of three and the value of face_degree_minus3). For example, when the syntax element “face_degree_minus3” has a value of 0, the face degree of the polygons is three (e.g., the polygons are triangles); when the syntax element “face_degree_minus3” has a value of 1, the face degree of the polygons is four (e.g., the polygons are quadrilaterals); when the syntax element “face_degree_minus3” has a value of 2, the face degree of the polygons is five (e.g., the polygons are of a pentagon shape); and the like.

Further, in the FIG. 14 example, when the syntax element “single_face_type” indicates that the polygons in the polygon mesh are not single type of polygons, a syntax element “two_face_type” is obtained from the bitstream, such as shown by (1404) in FIG. 14. The syntax element “two_face_type” indicates whether the polygons in the polygon mesh have two face types. When the syntax element “two_face_type” confirms that the polygons in the polygon mesh have two face types (e.g., shown by (1405) in FIG. 14), two syntax elements “face_degree1_minus3” and “face_degree2_minus3” are obtained from the bitstream, such as shown by (1406) and (1407) in FIG. 14. The syntax elements “face_degree1_minus3” and “face_degree2_minus3” indicate respective face degrees of the two types of polygons in the polygon mesh. For example, when the syntax element “face_degree1_minus3” has a value of 0, the face degree of a first type of polygons in the polygon mesh is three (e.g., the first type of polygons are triangles); when the syntax element “face_degree1_minus3” has a value of 1, the face degree of the first type of polygons is four (e.g., the first type of polygons are quadrilaterals); when the syntax element “face_degree1_minus3” has a value of 2, the face degree of the first type of polygons is five (e.g., the first type of polygons are of a pentagon shape); and the like. When the syntax element “face_degree2_minus3” has a value of 0, the face degree of a second type of polygons in the polygon mesh is three (e.g., the second type of polygons are triangles); when the syntax element “face_degree2_minus3” has a value of 1, the face degree of the second type of polygons is four (e.g., the first type of polygons are quadrilaterals); when the syntax element “face_degree2_minus3” has a value of 2, the face degree of the second type of polygons is five (e.g., the second type of polygons are of a pentagon shape); and the like.

It is noted that, in some aspects, when the mesh face type is “0” (triangle), the polygon mesh includes triangles only, thus the face degree is 3 for all polygon (triangles) in the polygon mesh; and when the mesh face type is “1” (quad), the polygon mesh includes quadrilaterals only, thus the face degree is 4 for all polygon (quadrilaterals) in the polygon mesh. For mesh face type “2” (tri-quad) and mesh face type “3” (polygon), a face degree mode can be further signaled.

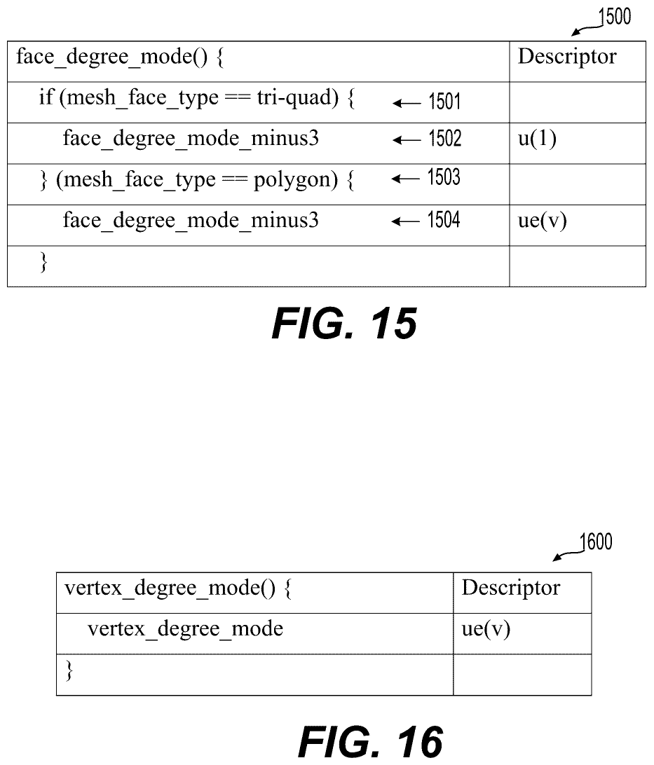

FIG. 15 shows a pseudo code (1500) for signaling a face degree mode of a polygon mesh in a bitstream in some examples. In the FIG. 15 example, a parameter “mesh_face_type” is suitable obtained, such as determined based on a codeword according to table (1300). The parameter “mesh_face_type” can one of “tri-quad” or “polygon” in some aspects.

In the FIG. 15 example, when the parameter “mesh_face_type” indicates that the mesh face type is “tri-quad” as shown by (1501), a syntax element “face_degree_mode_minus3” (one bit in FIG. 15) is obtained from the bitstream, such as shown by (1502) in FIG. 15. The syntax element “face_degree_mode_minus3” indicates the face degree mode of the polygons in the polygon mesh (e.g., a sum of three and the value of face_degree_mode_minus3) when the mesh face type is “tri-quad”. For example, when the syntax element “face_degree_mode_minus3” has a value of 0, the face degree mode of the polygons is three (e.g., the most frequent face degree in the polygon mesh is three, the most frequent polygons in the polygon mesh are triangles, a majority of polygons in the polygon mesh is triangle); when the syntax element “face_degree_mode_minus3” has a value of 1, the face degree mode of the polygons is four (e.g., the most frequent face degree in the polygon mesh is four, the most frequent polygons in the polygon mesh are quadrilaterals, a majority of polygons in the polygon mesh is quadrilateral).

In the FIG. 15 example, when the parameter “mesh_face_type” indicates that the mesh face type is “polygon” as shown by (1503), a syntax element “face_degree_mode_minus3” (multiple bits in FIG. 15) is obtained from the bitstream, such as shown by (1504) in FIG. 15. The syntax element “face_degree_mode_minus3” indicates the face degree mode of the polygons in the polygon mesh (e.g., a sum of three and the value of face_degree_mode_minus3). For example, when the syntax element “face_degree_mode_minus3” has a value of 2, the face degree mode of the polygons is five (e.g., the most frequent face degree in the polygon mesh is five, the most frequent polygons in the polygon mesh are pentagons, or a majority of polygons in the polygon mesh is pentagon).

In an aspect, the value of the vertex degree mode for a polygon mesh can be signaled directly in an example.

FIG. 16 shows a pseudo code (1600) for signaling a vertex degree mode of a polygon mesh in a bitstream in some examples. In the FIG. 16 example, a syntax element “vertex_degree_mode” is signaled using a plurality of bits. The value of the syntax element “vertex_degree_mode” is the most frequent vertex degree of the polygon mesh in an example.

In another aspect, the vertex degree mode can be signaled based on a prediction of the vertex degree mode. The prediction of the vertex degree mode is generated based on the face degree information of the polygon mesh, such as face degree mode of the polygon mesh, face type of the polygon mesh, and the like in some examples.

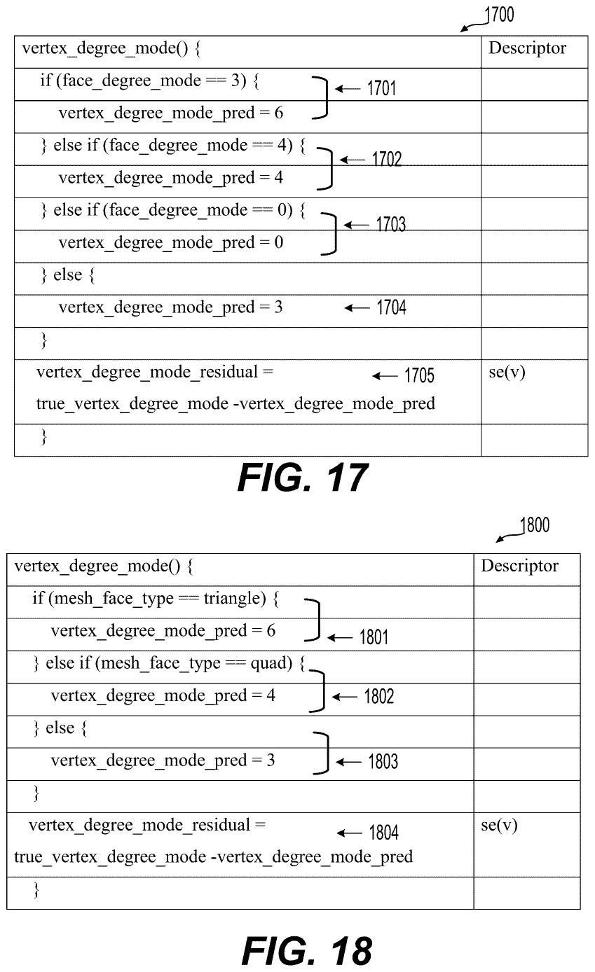

FIG. 17 shows a pseudo code (1700) for signaling a vertex degree mode of a polygon mesh in a bitstream in some examples.

In the FIG. 17 example, when the face degree mode is three, the vertex degree mode prediction is set to 6, as shown by (1701) in FIG. 17; when the face degree mode is four, the vertex degree mode prediction is set to 4, as shown by (1702) in FIG. 17; when the face degree mode is 0, the vertex degree mode prediction is set to 0, as shown by (1703) in FIG. 17; when the face degree mode is not any of three, four and zero, the vertex degree mode prediction is set to 3. Further, the vertex degree mode residual, which is the difference of the true vertex degree mode of the polygon mesh to the vertex degree mode prediction, is signaled, such as shown by (1705) in FIG. 17.

FIG. 18 shows a pseudo code (1800) for signaling a vertex degree mode of a polygon mesh in a bitstream in some examples.

In the FIG. 18 example, when the mesh face type is “triangle” (e.g., codeword is “00” in the table (1300) of FIG. 13), the vertex degree mode prediction is set to 6, as shown by (1801) in FIG. 18; when the mesh face type is quadrilateral (e.g., codeword is “01” in the table (1300) of FIG. 13), the vertex degree mode prediction is set to 4, as shown by (1802) in FIG. 18; when the mesh face type is not any of triangle and quadrilateral, the vertex degree mode prediction is set to 3, as shown by (1803) in FIG. 18. Further, the vertex degree mode residual, which is the difference of the true vertex degree mode of the polygon mesh to the vertex degree mode prediction, is signaled, such as shown by (1804) in FIG. 18.

In another aspect, the vertex degree mode can be coded using a codeword, such as a codeword of 2 bits.

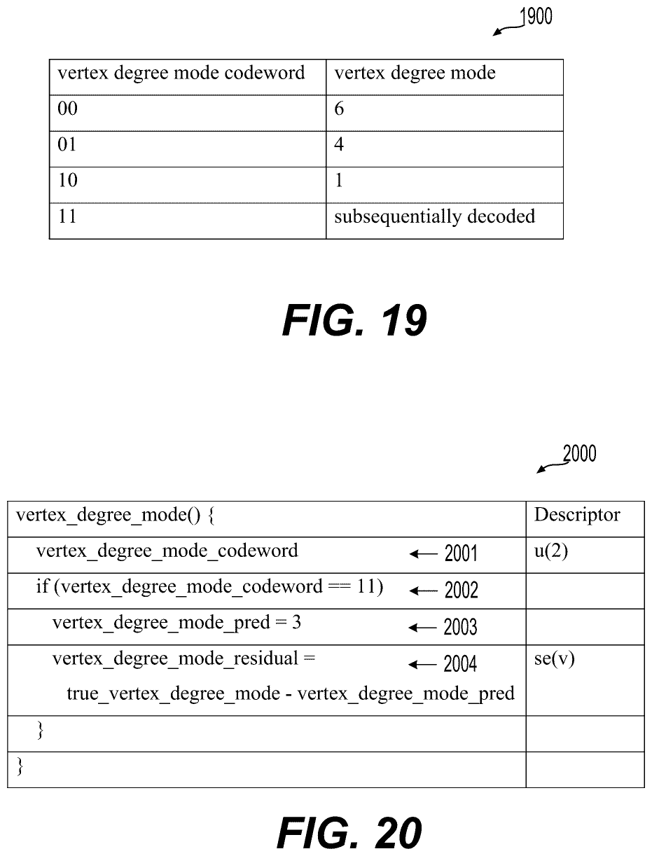

FIG. 19 shows a table (1900) of values of a codeword and corresponding vertex degree modes in some examples. For example, the codeword with value “00” indicates a vertex degree mode of 6 (e.g., the most frequent vertex degree is 6); the codeword with value “01” indicates a vertex degree mode of 4 (e.g., the most frequent vertex degree is 4); the codeword with value “10” indicates a vertex degree mode of 1 (e.g., the most frequent vertex degree is 1); the codeword with value “11” indicates that the value of the vertex degree mode is signaled subsequentially.

FIG. 20 shows a pseudo code (2000) for signaling a vertex degree mode of a polygon mesh in a bitstream in some examples.

In the FIG. 20 example, a syntax element “vertex_degree_mode_codeword” of two bits is obtained from the bitstream (shown by (2001) in FIG. 20), the syntax element “vertex_degree_mode_codeword” is a codeword that indicates the vertex degree mode according to the table (1800). When the syntax element “vertex_degree_mode_codeword” indicates that the vertex degree mode is signaled subsequentially (as shown by (2002) in FIG. 20), the vertex degree mode prediction is set to 3 as shown by (2003) in FIG. 20. Further, syntax element “vertex_degree_mode_residual” which has a value that is the difference of the true vertex degree mode of the polygon mesh to the vertex degree mode prediction is signaled, such as shown by (2004) in FIG. 20.

It is noted that the vertex degree mode pred in the FIG. 20 example can be set to any suitable integer value.

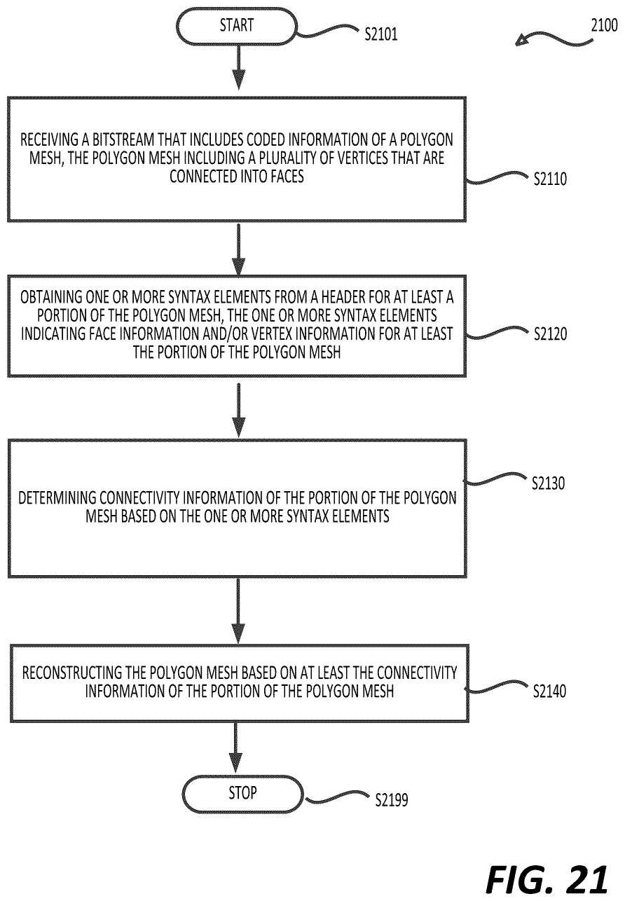

FIG. 21 shows a flow chart outlining a process (2100) according to an aspect of the disclosure. The process (2100) can be used in a mesh decoder. In various aspects, the process (2100) is executed by processing circuitry, such as the processing circuitry that performs functions of the 3D decoder (110), and the like. In some aspects, the process (2100) is implemented in software instructions, thus when the processing circuitry executes the software instructions, the processing circuitry performs the process (2100). The process starts at (S2101) and proceeds to (S2110).

At (S2110), a bitstream is received, the bitstream includes coded information of a polygon mesh, the polygon mesh includes a plurality of vertices that are connected into faces.

At (S2120), one or more syntax elements are obtained from a header for at least a portion of the polygon mesh, the one or more syntax elements indicate face information and/or vertex information for at least the portion of the polygon mesh, such as face information of a majority of faces in at least the portion of the polygon mesh, and vertex information of a majority of vertices in at least the portion of the polygon mesh.

At (S2130), connectivity information of the portion of the polygon mesh is determined based on the one or more syntax elements. For example, the polygon fan based technique or the dual-degree based technique are used to determine the connectivity of polygon mesh.

At (S2140), the polygon mesh is reconstructed based on at least the connectivity information of the portion of the polygon mesh.

In some examples, the one or more syntax elements are in a polygon mesh header of the polygon mesh, and the one or more syntax elements indicate face information and/or vertex information of the polygon mesh. In some examples, the one or more syntax elements are in a header of a group of connected components (GOCC) in the polygon mesh, and the one or more syntax elements indicate face information and/or vertex information of the group of connected components.

In some aspects, a face type of at least the portion of the polygon mesh is determined based on a value of a codeword in the one or more syntax elements, potential values of the codeword respectively correspond to potential face types, such as shown in FIG. 13. The potential face types include a first potential face type of triangles (e.g., all polygons), a second potential face type of quadrilaterals (e.g., all quadrilaterals), a third potential face type of a mix of triangles and quadrilaterals, and a fourth potential face type indicating an existence of at least a polygon other than triangles and quadrilaterals (e.g., at least one polygon is not triangle nor quadrilateral).

In an aspect, a face degree mode for at least the portion of the polygon mesh is determined based on the face type. For example, for the first potential face type, the face degree mode is 3; for the second potential face type, the face degree mode is 4. Further, when the face type is the third potential face type, the face degree mode is determined based on a syntax element of a single bit in the one or more syntax elements, such as 0 for the face degree mode of 3, and 1 for the face degree mode of 4 in an example. When the face type is the fourth potential face type, the face degree mode is determined based on a value that is determined based on a syntax element of a plurality of bits in the one or more syntax elements, such as shown in FIG. 15.

In some aspects, a vertex degree mode for at least the portion of the polygon mesh is determined based on a value that is signaled (e.g., explicitly signaled) by a syntax element of a plurality of bits from the one or more syntax elements, such as shown in FIG. 16.

In some aspects, a vertex degree mode for at least the portion of the polygon mesh is determined based on the face type, such as shown in FIG. 18. In some examples, a vertex degree mode prediction is set based on the face type. For example, the vertex degree mode is set to 6 when the face type is the first potential face type; the vertex degree mode is set to 4 when the face type is the second potential face type. Further, a vertex degree mode residual value is determined from a syntax element of a plurality of bits in the one or more syntax elements (e.g., the vertex degree mode residual value is explicitly signaled). The vertex degree mode prediction is combined (e.g., added) with the vertex degree mode residual value to obtain the vertex degree mode.

In some aspects, a vertex degree mode for at least the portion of the polygon mesh is determined based on the face degree mode, such as shown in FIG. 19. In some examples, a vertex degree mode prediction is set based on the face degree mode. A vertex degree mode residual value is determined from a syntax element of a plurality of bits in the one or more syntax elements. The vertex degree mode prediction is combined (added) with the vertex degree mode residual value to obtain the vertex degree mode.

In some aspects, a vertex degree mode of at least the portion of the polygon mesh is determined based on a value of a codeword, potential values of the codeword respectively corresponding to potential vertex degree modes, such as shown in FIG. 19. In some examples, when the value of the codeword indicates a subsequent decoding of the vertex degree mode, then a vertex degree mode prediction is set, a vertex degree mode residual value is determined from a syntax element of a plurality of bits in the one or more syntax elements, and the vertex degree mode prediction with the vertex degree mode residual value to obtain the vertex degree mode, such as shown in FIG. 20.

In some aspects, when the face information for at least the portion of the polygon mesh includes at least one of a face type for the portion of the polygon mesh, and a face degree mode for the portion of the polygon mesh, a face degree of each face in the portion of the polygon mesh can be determined based on at least one of the face type and/or the face degree mode. For example, when the face type is “triangle”, each of the faces has a face degree of 3; when the face type is “quadrilateral”, each of the faces has a face degree of. In some examples, when the face type is “tri-quad” and the face degree mode is “3”, for a face of a face degree of 3, no additional signaling is needed, for a face of a face degree of 4, a bit can be used to indicate the face degree of the face. In some examples, when the face type is “tri-quad” and the face degree mode is “4”, for a face of a face degree of 4, no additional signaling is needed, for a face of a face degree of 3, a bit can be used to indicate the face degree of the face.

In some aspects, the vertex information for at least the portion of the polygon mesh includes a vertex degree mode for the portion of the polygon mesh, and a vertex degree of a vertex in the portion of the polygon mesh is determined based on the vertex degree mode. For example, when a vertex degree of a vertex in the portion of the polygon mesh is consistent (the same) as the vertex degree mode of the portion of the polygon mesh, no additional signaling is needed; when a vertex degree of a vertex in the portion of the polygon mesh is different from the vertex degree mode of the portion of the polygon mesh, a difference can be suitably signaled.

Then, the process proceeds to (S2199) and terminates.

The process (2100) can be suitably adapted. Step(s) in the process (2100) can be modified and/or omitted. Additional step(s) can be added. Any suitable order of implementation can be used.

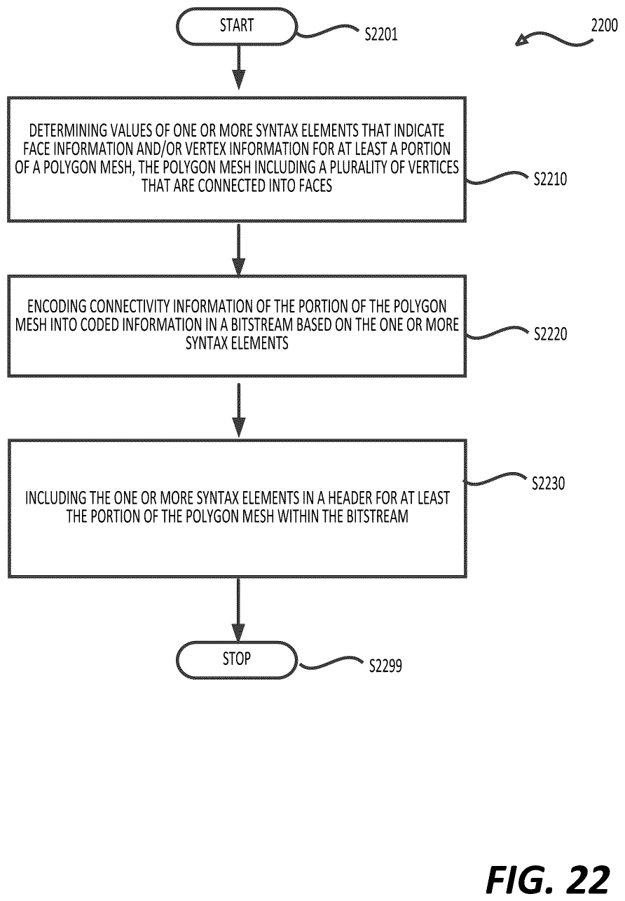

FIG. 22 shows a flow chart outlining a process (2200) according to an aspect of the disclosure. The process (2200) can be used in a mesh encoder. In various aspects, the process (2200) is executed by processing circuitry, such as the processing circuitry that performs functions of the 3D encoder (103), and the like. In some aspects, the process (2200) is implemented in software instructions, thus when the processing circuitry executes the software instructions, the processing circuitry performs the process (2200). The process starts at (S2201) and proceeds to (S2210).

At (S2210), values of one or more syntax elements that indicate face information and/or vertex information for at least a portion of a polygon mesh are determined the polygon mesh includes a plurality of vertices that are connected into faces. For example, the face information for at least the portion of the polygon mesh is a face degree mode that indicates a face degree of a majority of faces in at least the portion of the polygon mesh. In another example, the vertex information for at least the portion of the polygon mesh is vertex degree mode that indicates a vertex degree of a majority of vertices in at least the portion of the polygon mesh.

At (S2220), connectivity information of the portion of the polygon mesh are encoded into coded information in a bitstream based on the one or more syntax elements. For example, when a face belongs to the majority of the faces with a face degree indicated by the face degree mode, no additional signaling is needed; and when a face has a different face degree from the face degree that is indicated by the face degree mode, then a difference can be suitably encoded for the face. In another example, when a vertex belongs to the majority of the vertices with a vertex degree that is indicated by the vertex degree mode, no additional signaling is needed; and when a vertex has a different vertex degree from the vertex degree that is indicated by the vertex degree mode, then a difference can be suitably encoded for the vertex.

At (S2230), the one or more syntax elements are included in a header for at least the portion of the polygon mesh within the bitstream.

In some aspects, when the one or more syntax elements indicate face information and/or vertex information of the polygon mesh, the one or more syntax elements are included in a polygon mesh header of the polygon mesh; when the one or more syntax elements indicate face information and/or vertex information of a group of connected components (GOCC) in the polygon mesh, the one or more syntax elements are included in a header of the group of connected components.

In some aspects, a value of a codeword in the one or more syntax elements is determined based on a face type of at least the portion of the polygon mesh, potential values of the codeword respectively correspond to potential face types, the potential face types includes a first potential face type of triangles, a second potential face type of quadrilaterals, a third potential face type of a mix of triangles and quadrilaterals, and a fourth potential face type indicating an existence of at least a polygon other than triangles and quadrilaterals, such as shown in FIG. 13.

In some examples, a value of a syntax element for indicating a face degree mode for at least the portion of the polygon mesh is determined based on the face type, such as shown in FIG. 15. For example, when the face type is the third potential face type, the syntax element is of a single bit; and when the face type is the fourth potential face type, the syntax element is of a plurality of bits.

In some examples, a value of a syntax element is set to be a vertex degree mode for at least the portion of the polygon mesh, the syntax element has a plurality of bits, such as shown in FIG. 16.

In some examples, a value of a syntax element for indicating a vertex degree mode of at least the portion of the polygon mesh is determined based on the face type. For example, the syntax element corresponds to a vertex degree mode residual. In an example, a vertex degree mode prediction is set based on the face type; and the value of the syntax element is calculated as a difference between the (true) vertex degree mode of at least the portion of the polygon mesh and the vertex degree mode prediction, such as shown in FIG. 18.

In some examples, a value of a syntax element for indicating a vertex degree mode of at least the portion of the polygon mesh is determined based on the face degree mode. For example, the syntax element corresponds to a vertex degree mode residual. In an example, a vertex degree mode prediction is set based on the face degree mode, and the value of the syntax element is calculated as a difference between the (true) vertex degree mode of at least the portion of the polygon mesh and the vertex degree mode prediction, such as shown in FIG. 17.

In some examples, a value of a codeword in the one or more syntax elements is set based on a vertex degree mode of at least the portion of the polygon mesh, potential values of the codeword respectively correspond to potential vertex degree modes. In an example, the codeword is set of a specific value that indicates a syntax element in the one or more syntax elements corresponding to a vertex degree mode residual. A vertex degree mode prediction is suitably set (e.g., default value) and a value of the syntax element is calculated as a difference between the (true) vertex degree mode of at least the portion of the polygon mesh and the vertex degree mode prediction.

In some aspects, the face information for at least the portion of the polygon mesh includes at least one of a face type for the portion of the polygon mesh, and a face degree mode for the portion of the polygon mesh, and a face degree of a face in the portion of the polygon mesh is encoded based on at least one of the face type and/or the face degree mode.

In some aspects, the vertex information for at least the portion of the polygon mesh includes a vertex degree mode for the portion of the polygon mesh, and a vertex degree of a vertex in the portion of the polygon mesh is encoded based on the vertex degree mode.

Then, the process proceeds to (S2299) and terminates.

The process (2200) can be suitably adapted. Step(s) in the process (2200) can be modified and/or omitted. Additional step(s) can be added. Any suitable order of implementation can be used.

According to an aspect of the disclosure, a method of processing mesh data is provided. In the method, a conversion between a mesh media file and a bitstream of mesh media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a polygon mesh, the polygon mesh includes a plurality of vertices that are connected into faces. The format rule specifies that: one or more syntax elements are obtained from a header for at least a portion of the polygon mesh, the one or more syntax elements indicating face information and/or vertex information for at least the portion of the polygon mesh; connectivity information of the portion of the polygon mesh is determined based on the one or more syntax elements; and the polygon mesh is reconstructed based on at least the connectivity information of the portion of the polygon mesh.

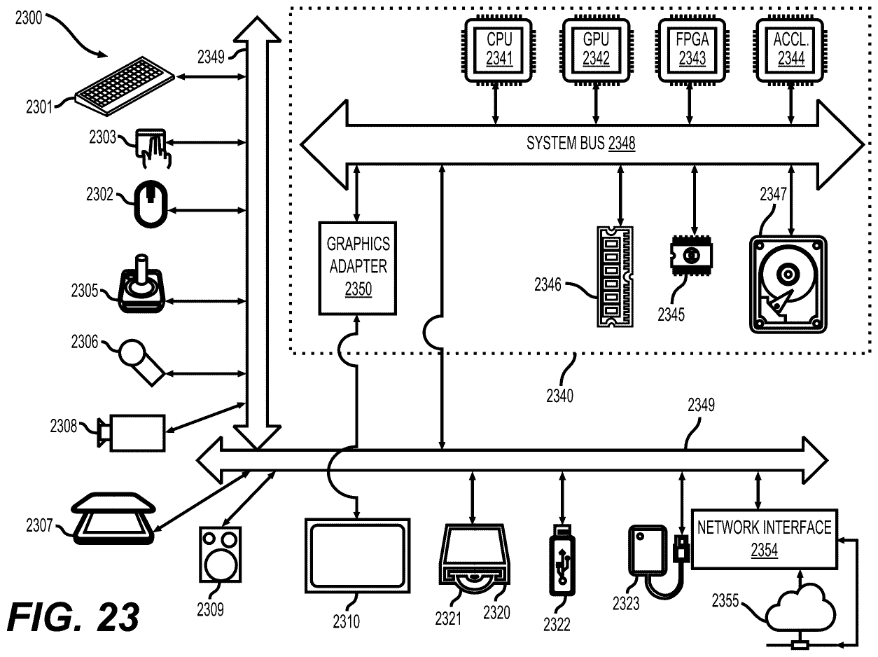

The techniques described above, can be implemented as computer software using computer-readable instructions and physically stored in one or more computer-readable media. For example, FIG. 23 shows a computer system (2300) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 23 for computer system (2300) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (2300).

Computer system (2300) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2301), mouse (2302), trackpad (2303), touch screen (2310), data-glove (not shown), joystick (2305), microphone (2306), scanner (2307), camera (2308).

Computer system (2300) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2310), data-glove (not shown), or joystick (2305), but there can also be tactile feedback devices that do not serve as input devices), audio output devices (such as: speakers (2309), headphones (not depicted)), visual output devices (such as screens (2310) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (2300) can also include human accessible storage devices and their associated media such as optical media including CD/DVD ROM/RW (2320) with CD/DVD or the like media (2321), thumb-drive (2322), removable hard drive or solid state drive (2323), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2300) can also include an interface (2354) to one or more communication networks (2355). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2349) (such as, for example USB ports of the computer system (2300)); others are commonly integrated into the core of the computer system (2300) by attachment to a system bus as described below (for example Ethernet interface into a PC computer system or cellular network interface into a smartphone computer system). Using any of these networks, computer system (2300) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2340) of the computer system (2300).

The core (2340) can include one or more Central Processing Units (CPU) (2341), Graphics Processing Units (GPU) (2342), specialized programmable processing units in the form of Field Programmable Gate Areas (FPGA) (2343), hardware accelerators for certain tasks (2344), graphics adapters (2350), and so forth. These devices, along with Read-only memory (ROM) (2345), Random-access memory (2346), internal mass storage such as internal non-user accessible hard drives, SSDs, and the like (2347), may be connected through a system bus (2348). In some computer systems, the system bus (2348) can be accessible in the form of one or more physical plugs to enable extensions by additional CPUs, GPU, and the like. The peripheral devices can be attached either directly to the core's system bus (2348), or through a peripheral bus (2349). In an example, the screen (2310) can be connected to the graphics adapter (2350). Architectures for a peripheral bus include PCI, USB, and the like.

CPUs (2341), GPUs (2342), FPGAs (2343), and accelerators (2344) can execute certain instructions that, in combination, can make up the aforementioned computer code. That computer code can be stored in ROM (2345) or RAM (2346). Transitional data can also be stored in RAM (2346), whereas permanent data can be stored for example, in the internal mass storage (2347). Fast storage and retrieve to any of the memory devices can be enabled through the use of cache memory, that can be closely associated with one or more CPU (2341), GPU (2342), mass storage (2347), ROM (2345), RAM (2346), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2300), and specifically the core (2340) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2340) that are of non-transitory nature, such as core-internal mass storage (2347) or ROM (2345). The software implementing various aspects of the present disclosure can be stored in such devices and executed by core (2340). A computer-readable medium can include one or more memory devices or chips, according to particular needs. The software can cause the core (2340) and specifically the processors therein (including CPU, GPU, FPGA, and the like) to execute particular processes or particular parts of particular processes described herein, including defining data structures stored in RAM (2346) and modifying such data structures according to the processes defined by the software. In addition or as an alternative, the computer system can provide functionality as a result of logic hardwired or otherwise embodied in a circuit (for example: accelerator (2344)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1). A method of mesh decoding, including: receiving a bitstream that includes coded information of a polygon mesh, the polygon mesh including a plurality of vertices that are connected into faces; obtaining one or more syntax elements from a header for at least a portion of the polygon mesh, the one or more syntax elements indicating face information and/or vertex information for at least the portion of the polygon mesh; determining connectivity information of the portion of the polygon mesh based on the one or more syntax elements; and reconstructing the polygon mesh based on at least the connectivity information of the portion of the polygon mesh.
(2). The method of feature (1), in which: when the one or more syntax elements are in a polygon mesh header of the polygon mesh, the one or more syntax elements indicate face information and/or vertex information of the polygon mesh; or when the one or more syntax elements are in a header of a group of connected components (GOCC) in the polygon mesh, the one or more syntax elements indicate face information and/or vertex information of the group of connected components.
(3). The method of any of features (1) to (2), further including: determining a face type of at least the portion of the polygon mesh based on a value of a codeword in the one or more syntax elements, potential values of the codeword respectively corresponding to potential face types, the potential face types including a first potential face type of triangles, a second potential face type of quadrilaterals, a third potential face type of a mix of triangles and quadrilaterals, and a fourth potential face type indicating an existence of at least a polygon other than triangles and quadrilaterals.
(4). The method of any of features (1) to (3), further including: determining a face degree mode for at least the portion of the polygon mesh based on the face type.
(5). The method of any of features (1) to (4), in which the determining the face degree mode includes at least one of: when the face type is the third potential face type, determining the face degree mode based on a syntax element of a single bit in the one or more syntax elements; and when the face type is the fourth potential face type, determining the face degree mode based on a value that is determined based on a syntax element of a plurality of bits in the one or more syntax elements.
(6). The method of any of features (1) to (5), further including: determining a vertex degree mode for at least the portion of the polygon mesh based on a value that is determined based on a syntax element of a plurality of bits from the one or more syntax elements.
(7). The method of any of features (1) to (6), further including: determining a vertex degree mode for at least the portion of the polygon mesh based on the face type.
(8). The method of any of features (1) to (7), in which the determining the vertex degree mode includes: setting a vertex degree mode prediction based on the face type; determining a vertex degree mode residual value from a syntax element of a plurality of bits in the one or more syntax elements; and combining the vertex degree mode prediction with the vertex degree mode residual value to obtain the vertex degree mode.
(9). The method of any of features (1) to (8), further including: determining a vertex degree mode for at least the portion of the polygon mesh based on the face degree mode.
(10). The method of any of features (1) to (9), in which the determining the vertex degree mode includes: setting a vertex degree mode prediction based on the face degree mode; determining a vertex degree mode residual value from a syntax element of a plurality of bits in the one or more syntax elements; and combining the vertex degree mode prediction with the vertex degree mode residual value to obtain the vertex degree mode.
(11). The method of any of features (1) to (10), further including: determining a vertex degree mode of at least the portion of the polygon mesh based on a value of a codeword, potential values of the codeword respectively corresponding to potential vertex degree modes.
(12). The method of any of features (1) to (11), in which when the value of the codeword indicates a subsequent decoding of the vertex degree mode, the method includes: setting a vertex degree mode prediction; determining a vertex degree mode residual value from a syntax element of a plurality of bits in the one or more syntax elements; and combining the vertex degree mode prediction with the vertex degree mode residual value to obtain the vertex degree mode.
(13). The method of any of features (1) to (12), in which the face information for at least the portion of the polygon mesh includes at least one of a face type for the portion of the polygon mesh, and a face degree mode for the portion of the polygon mesh, and the determining the connectivity information includes: determining a face degree of a face in the portion of the polygon mesh based on at least one of the face type and/or the face degree mode.
(14). The method of any of features (1) to (13), in which the vertex information for at least the portion of the polygon mesh includes a vertex degree mode for the portion of the polygon mesh, and the determining the connectivity information includes: determining a vertex degree of a vertex in the portion of the polygon mesh based on the vertex degree mode.
(15). A method of mesh encoding, including: determining values of one or more syntax elements that indicate face information and/or vertex information for at least a portion of a polygon mesh, the polygon mesh including a plurality of vertices that are connected into faces; encoding connectivity information of the portion of the polygon mesh into coded information in a bitstream based on the one or more syntax elements; and including the one or more syntax elements in a header for at least the portion of the polygon mesh within the bitstream.
(16). The method of feature (15), in which: when the one or more syntax elements indicate face information and/or vertex information of the polygon mesh, the one or more syntax elements are included in a polygon mesh header of the polygon mesh; or when the one or more syntax elements indicate face information and/or vertex information of a group of connected components (GOCC) in the polygon mesh, the one or more syntax elements are included in a header of the group of connected components.
(17). The method of any of features (15) to (16), in which the determining the values of the one or more syntax elements includes: determining a value of a codeword in the one or more syntax elements based on a face type of at least the portion of the polygon mesh, potential values of the codeword respectively corresponding to potential face types, the potential face types including a first potential face type of triangles, a second potential face type of quadrilaterals, a third potential face type of a mix of triangles and quadrilaterals, and a fourth potential face type indicating an existence of at least a polygon other than triangles and quadrilaterals.
(18). The method of any of features (15) to (17), in which the determining the values of the one or more syntax elements includes: determining a value of a syntax element for indicating a face degree mode for at least the portion of the polygon mesh based on the face type.
(19). The method of any of features (15) to (18), in which: when the face type is the third potential face type, the syntax element is of a single bit; and when the face type is the fourth potential face type, the syntax element is of a plurality of bits.
(20). The method of any of features (15) to (19), in which the determining the values of the one or more syntax elements includes: setting a value of a syntax element to be a vertex degree mode for at least the portion of the polygon mesh, the syntax element having a plurality of bits.
(21). The method of any of features (15) to (20), in which the determining the values of the one or more syntax elements includes: determining a value of a syntax element for indicating a vertex degree mode of at least the portion of the polygon mesh based on the face type.
(22). The method of any of features (15) to (21), in which the syntax element corresponds to a vertex degree mode residual, and the determining the value of the syntax element includes: setting a vertex degree mode prediction based on the face type; and calculating the value of the syntax element as a difference between the vertex degree mode of at least the portion of the polygon mesh and the vertex degree mode prediction.
(23). The method of any of features (15) to (22), in which the determining the values of the one or more syntax elements includes: determining a value of a syntax element for indicating a vertex degree mode of at least the portion of the polygon mesh based on the face degree mode.
(24). The method of any of features (15) to (23), in which the syntax element corresponds to a vertex degree mode residual, and the determining the value of the syntax element includes: setting a vertex degree mode prediction based on the face degree mode; and calculating the value of the syntax element as a difference between the vertex degree mode of at least the portion of the polygon mesh and the vertex degree mode prediction.
(25). The method of any of features (15) to (24), in which the determining the values of the one or more syntax elements includes: setting a value of a codeword in the one or more syntax elements based on a vertex degree mode of at least the portion of the polygon mesh, potential values of the codeword respectively corresponding to potential vertex degree modes.
(26). The method of any of features (15) to (25), further including: setting the codeword of a specific value that indicates a syntax element in the one or more syntax elements corresponds to a vertex degree mode residual; setting a vertex degree mode prediction; and calculating a value of the syntax element as a difference between the vertex degree mode of at least the portion of the polygon mesh and the vertex degree mode prediction.
(27). The method of any of features (15) to (26), in which the face information for at least the portion of the polygon mesh includes at least one of a face type for the portion of the polygon mesh, and a face degree mode for the portion of the polygon mesh, and the encoding the connectivity information includes: encoding a face degree of a face in the portion of the polygon mesh based on at least one of the face type and/or the face degree mode.
(28). The method of any of features (15) to (27), in which the vertex information for at least the portion of the polygon mesh includes a vertex degree mode for the portion of the polygon mesh, and the encoding the connectivity information includes: encoding a vertex degree of a vertex in the portion of the polygon mesh based on the vertex degree mode.
(29). A non-transitory computer-readable storage medium storing instructions which when executed by a processor cause the processor to perform an encoding method. The encoding method includes determining values of one or more syntax elements that indicate face information and/or vertex information for at least a portion of a polygon mesh, the polygon mesh including a plurality of vertices that are connected into faces; encoding connectivity information of the portion of the polygon mesh into coded information in a bitstream based on the one or more syntax elements; including the one or more syntax elements in a header for at least the portion of the polygon mesh within the bitstream; and transmitting the bitstream.
(30). A method of processing mesh data, the method including: processing a bitstream that includes mesh data according to a format rule, in which: the bitstream carries coded information of a polygon mesh, the polygon mesh including a plurality of vertices that are connected into faces; and the format rule specifies that: one or more syntax elements are obtained from a header for at least a portion of the polygon mesh, the one or more syntax elements indicating face information and/or vertex information for at least the portion of the polygon mesh; connectivity information of the portion of the polygon mesh is determined based on the one or more syntax elements; and the polygon mesh is reconstructed based on at least the connectivity information of the portion of the polygon mesh.
(31). An apparatus for mesh decoding, including processing circuitry that is configured to perform the method of any of features (1) to (14).
(32). An apparatus for mesh encoding, including processing circuitry that is configured to perform the method of any of features (15) to (28).
(31). A non-transitory computer-readable storage medium storing instructions which when executed by at least one processor cause the at least one processor to perform the method of any of features (1) to (28).

What is claimed is:

1. A method of mesh decoding, comprising:
receiving a bitstream that includes coded information of a polygon mesh, the polygon mesh including a plurality of vertices that are connected into faces;
obtaining one or more syntax elements from a header for at least a portion of the polygon mesh, the one or more syntax elements indicating face information and/or vertex information for at least the portion of the polygon mesh;
determining connectivity information of the portion of the polygon mesh based on the one or more syntax elements; and
reconstructing the polygon mesh based on at least the connectivity information of the portion of the polygon mesh.

2. The method of claim 1, wherein:
when the one or more syntax elements are in a polygon mesh header of the polygon mesh, the one or more syntax elements indicate face information and/or vertex information of the polygon mesh; or
when the one or more syntax elements are in a header of a group of connected components (GOCC) in the polygon mesh, the one or more syntax elements indicate face information and/or vertex information of the group of connected components.

3. The method of claim 1, further comprising:
determining a face type of at least the portion of the polygon mesh based on a value of a codeword in the one or more syntax elements, potential values of the codeword respectively corresponding to potential face types, the potential face types including a first potential face type of triangles, a second potential face type of quadrilaterals, a third potential face type of a mix of triangles and quadrilaterals, and a fourth potential face type indicating an existence of at least a polygon other than triangles and quadrilaterals.

4. The method of claim 3, further comprising:
determining a face degree mode for at least the portion of the polygon mesh based on the face type.

5. The method of claim 4, wherein the determining the face degree mode comprises at least one of:
when the face type is the third potential face type, determining the face degree mode based on a syntax element of a single bit in the one or more syntax elements; and
when the face type is the fourth potential face type, determining the face degree mode based on a value that is determined based on a syntax element of a plurality of bits in the one or more syntax elements.

6. The method of claim 1, further comprising:
determining a vertex degree mode for at least the portion of the polygon mesh based on a value that is determined based on a syntax element of a plurality of bits from the one or more syntax elements.

7. The method of claim 3, further comprising:
determining a vertex degree mode for at least the portion of the polygon mesh based on the face type.

8. The method of claim 7, wherein the determining the vertex degree mode comprises:
setting a vertex degree mode prediction based on the face type;
determining a vertex degree mode residual value from a syntax element of a plurality of bits in the one or more syntax elements; and
combining the vertex degree mode prediction with the vertex degree mode residual value to obtain the vertex degree mode.

9. The method of claim 4, further comprising:
determining a vertex degree mode for at least the portion of the polygon mesh based on the face degree mode.

10. The method of claim 9, wherein the determining the vertex degree mode comprises:
setting a vertex degree mode prediction based on the face degree mode;
determining a vertex degree mode residual value from a syntax element of a plurality of bits in the one or more syntax elements; and
combining the vertex degree mode prediction with the vertex degree mode residual value to obtain the vertex degree mode.

11. The method of claim 1, further comprising:
determining a vertex degree mode of at least the portion of the polygon mesh based on a value of a codeword, potential values of the codeword respectively corresponding to potential vertex degree modes.

12. The method of claim 11, wherein when the value of the codeword indicates a subsequent decoding of the vertex degree mode, the method comprises:
setting a vertex degree mode prediction;
determining a vertex degree mode residual value from a syntax element of a plurality of bits in the one or more syntax elements; and
combining the vertex degree mode prediction with the vertex degree mode residual value to obtain the vertex degree mode.

13. The method of claim 1, wherein the face information for at least the portion of the polygon mesh comprises at least one of a face type for the portion of the polygon mesh, and a face degree mode for the portion of the polygon mesh, and the determining the connectivity information comprises:
determining a face degree of a face in the portion of the polygon mesh based on at least one of the face type and/or the face degree mode.

14. The method of claim 1, wherein the vertex information for at least the portion of the polygon mesh comprises a vertex degree mode for the portion of the polygon mesh, and the determining the connectivity information comprises:
determining a vertex degree of a vertex in the portion of the polygon mesh based on the vertex degree mode.

15. A method of mesh encoding, comprising:
determining values of one or more syntax elements that indicate face information and/or vertex information for at least a portion of a polygon mesh, the polygon mesh including a plurality of vertices that are connected into faces;
encoding connectivity information of the portion of the polygon mesh into coded information in a bitstream based on the one or more syntax elements; and
including the one or more syntax elements in a header for at least the portion of the polygon mesh within the bitstream.

16. The method of claim 15, wherein:
when the one or more syntax elements indicate face information and/or vertex information of the polygon mesh, the one or more syntax elements are included in a polygon mesh header of the polygon mesh; or
when the one or more syntax elements indicate face information and/or vertex information of a group of connected components (GOCC) in the polygon mesh, the one or more syntax elements are included in a header of the group of connected components.

17. The method of claim 15, wherein the determining the values of the one or more syntax elements comprises:
determining a value of a codeword in the one or more syntax elements based on a face type of at least the portion of the polygon mesh, potential values of the codeword respectively corresponding to potential face types, the potential face types including a first potential face type of triangles, a second potential face type of quadrilaterals, a third potential face type of a mix of triangles and quadrilaterals, and a fourth potential face type indicating an existence of at least a polygon other than triangles and quadrilaterals.

18. The method of claim 17, wherein the determining the values of the one or more syntax elements comprises:
determining a value of a syntax element for indicating a face degree mode for at least the portion of the polygon mesh based on the face type.

19. The method of claim 18, wherein:
when the face type is the third potential face type, the syntax element is of a single bit; and
when the face type is the fourth potential face type, the syntax element is of a plurality of bits.

20. A non-transitory computer-readable storage medium storing instructions which when executed by a processor cause the processor to perform an encoding method comprising:
determining values of one or more syntax elements that indicate face information and/or vertex information for at least a portion of a polygon mesh, the polygon mesh including a plurality of vertices that are connected into faces;
encoding connectivity information of the portion of the polygon mesh into coded information in a bitstream based on the one or more syntax elements;
including the one or more syntax elements in a header for at least the portion of the polygon mesh within the bitstream; and
transmitting the bitstream.
